(19) United States
(12) Patent Application Publication
(10) Pub. No.: US 2017/0087578 A1
(43) Pub. Date: Mar. 30, 2017

(54) APPARATUS FOR COATING WELDED PIPE JOINTS

(71) Applicant: KEYMAY INDUSTRIES LTD., Sherwood Park (CA)

(72) Inventors: Donald Owen GUNN, Sherwood Park (CA); Daniel Owen GUNN, Sherwood Park (CA); Carl COLE, Bon Accord (CA); Karrie Albert Dee BEAUDRY, Sherwood Park (CA)

(21) Appl. No.: 15/266,246

(22) Filed: Sep. 15, 2016

Related U.S. Application Data
(60) Provisional application No. 62/232,749, filed on Sep. 25, 2015.

(51) Int. Cl. B05B 13/04; B05B 7/14; B05D 7/14; B05D 1/12; B05D 3/02

(52) U.S. Cl. CPC B05B 13/0436; B05D 1/12; B05D 3/0218; B05D 7/146; B05B 7/1459

(57) ABSTRACT

An apparatus for powder coating a welded pipe joint includes a coating head having a powder chamber and at least one vacuum chamber. The coating head is mounted to a carriage operable to circumferentially traverse a pipe workpiece. The powder chamber has at least one inlet for receiving an air/powder suspension, and at least one outlet for delivering the air/powder suspension to a pre-heated weld zone of the pipe, such that the suspension fuses to and coats the weld zone. The vacuum chamber has at least one powder inlet for receiving excess air/powder suspension from the weld zone, and is connectable to a source of vacuum for exhausting the excess air/powder suspension from the weld zone. The coating thickness in the weld zone can be controlled by coordinated regulation of the air/powder flow rate into the powder chamber and the exhaust flow rate from the vacuum chamber.

### FIELD OF THE DISCLOSURE

The present disclosure relates in general to apparatus and methods for applying protective coatings to welded joints between abutting ends of pipe sections, and relates in particular (but not exclusively) to apparatus and methods for coating field-welded pipe joints with fusion-bonded epoxy powder (FBE).

### BACKGROUND

Pipelines for conveying petroleum fluids (e.g., crude oil and natural gas), water, and other fluids are typically constructed by welding a series of pipe sections end-to-end, to create a finished pipeline of desired length. The welded joints between the pipe sections may in some cases be shop welds, but the joints are commonly made by field welding as well. Particularly for pipelines that will be buried in the ground and/or will pass through water or very wet soil, the pipe sections typically have a shop-applied protective coating of one type or another. In order to make either a shop-welded joint or a field-welded joint between two coated pipe sections, it is necessary to remove (or “cut back”) the coating for a suitable distance away from the ends of the pipe sections being joined, to facilitate preparation of the pipe ends for welding followed by performance of the required welding procedure.

After the weld has been completed, it is typically ground down to near the outer surface of the pipe, and the entire weld zone (i.e., a zone comprising the weld itself and the uncoated region on either side of the weld) is prepared (typically by sandblasting) for application of a suitable protective coating, in order to provide continuity of protection against corrosion along the length of the finished pipeline. The coating material applied to the weld zone will typically match the shop-applied coating on the pipe sections.

Various types of coatings and coverings have been used for protecting pipe. One process that is commonly used for this purpose is fusion-bonded epoxy (FBE). This process (which will be known to persons skilled in the art) involves heating a metal workpiece (such as a pipe) using suitable heating means (such as induction heating, which also will be known to persons skilled in the art), and then applying a powderized coating material (commonly a thermoset material) to the heated area of the workpiece, whereupon the coating material will be melted by the heat of the workpiece and fused thereto upon cooling of the workpiece. The coating material is typically delivered to the workpiece in the form of an air/powder suspension so that it is readily conveyable by pneumatic means. Application of the coating to the workpiece must be done in a controlled manner. Variables such as coating thickness, uniformity, cure, and bond to the pipe are all factors that contribute to the performance of the coating.

A particular problem that can occur when coating pipe joints using known powder coating apparatus is inadequate or excessive coating thickness. It is common sense that the coating thickness over the weld zone should not be less than the thickness of the shop-applied coating that was cut back from the pipe ends in preparation for welding the joint. However, it is less intuitive that the coating thickness over the weld zone also should not greatly exceed the shop coating thickness.

This consideration relates to the fact that a cured powder coating is somewhat brittle rather than resilient. If kept thin enough, while still sufficiently thick to provide the required protection to the pipe, the coating can withstand a certain amount of structural stresses induced by external loads acting on the pipe (e.g., bending stresses) without cracking. However, if the coating is too thick, structural stresses in the pipe can result in cracking and even spalling of the coating, thus impairing or destroying the protection provided by the coating. This is one reason why specifications for coating field welds on pipelines commonly stipulate maximum as well as minimum coating thicknesses. In practice, however, compliance with specified maximum coating thicknesses is commonly not met, often due to inherent limitations of the coating apparatus used.

For the foregoing reasons, there is a need for powder coating apparatus that can control both the minimum and maximum thicknesses of an applied powder coating within close tolerances, more effectively and more reliably than known powder coating apparatus.

### BRIEF SUMMARY

In general terms, the present disclosure teaches powder coating apparatus having a coating application head (“coating head”) featuring a powder delivery chamber (“powder chamber”) connectable to a source of air/powder suspension, plus two vacuum chambers, one on each side of the powder chamber. The powder chamber has one or more powder inlets, for introducing a flow of air-suspended epoxy powder. The lower region of the powder chamber has at least one powder discharge outlet for delivering the air/powder suspension to a pipe workpiece. The vacuum chambers are connectable to a source of vacuum, for exhausting excess air/powder suspension from the work zone of the coating head (i.e., the weld zone). Each vacuum chamber has at least one vacuum inlet to facilitate exhausting of excess air/powder suspension from the weld zone.

The coating head is mounted in, on, or to a coating head carriage, which in turn is mountable to a pipe and operable to traverse a circumferential path along the external surface of the pipe. The coating head is mounted to the carriage with the powder discharge outlet(s) of the powder chamber and the vacuum inlets of the vacuum chambers directed radially inward, such that when the carriage is mounted on a pipe, the powder discharge outlet(s) and the vacuum inlets will be directly facing and closely adjacent to the pipe surface. The gap between the pipe surface and the walls of the radially-inward edges of the powder chamber will be set to match the desired finished coating thickness plus a selected tolerance.

With the powder chamber being fed by a source of air/powder mixture, and with the vacuum chambers being connected to a source of vacuum, the carriage and coating head can then be traversed around the perimeter of the pipe, with the powder chamber extending longitudinally each side of the welded pipe joint so as to meet the shop-applied coating beyond the cut-back areas thereof. The rate of flow of air/powder suspension over the heated weld zone—and therefore the thickness of the finished coating over the weld zone—can be controlled by coordinated regulation of the air/powder flow rate into the powder chamber and the exhaust flow rate from the vacuum chambers.

For example, for a given air/powder inflow rate into the powder chamber, the finished coating thickness can be reduced by increasing the exhaust flow rate, or increased by decreasing the exhaust flow rate. In this sense, the vacuum feature of the coating head can be adjusted as necessary to “fine-tune” the coating thickness, without necessarily needing to adjust the powder inflow rate. At the same time, the vacuum feature exhausts substantially all unused powder from the weld zone, thus mitigating or eliminating associated environmental hazards.

Accordingly, in a first aspect the present disclosure teaches a coating head having a powder chamber having one or more powder inlets and one or more powder discharge outlets, with the powder inlets being connectable to a source of a powderized coating material. The coating head also includes a vacuum chamber having one or more vacuum inlets and one or more vacuum outlet ports, which are being connectable to a source of vacuum. The coating head is mountable on a coating head carriage adapted for mounting to a pipe so as to be circumferentially traversable around the pipe while maintaining the coating head a desired radial distance from the pipe surface, with the one or more powder discharge outlets being directed radially inward toward the surface of the pipe to enable the flow of coating material to a selected pipe surface region, and with the one or more vacuum inlets being positioned to enable the flow of coating material from the selected pipe surface region into the vacuum chamber. Both the rate of flow of powderized coating material into the powder chamber and the rate of flow of powderized coating material into the vacuum chamber are selectively variable.

The powder chamber may share a common wall with one or more of the one or more vacuum chambers. Alternatively, the powder chamber may be physically separate from one or more of the vacuum chambers.

In a second aspect, the present disclosure teaches a method of applying a powder coating to a selected area of a pipe, such as a weld zone, including the following steps (in any operationally suitable order):
providing a powder coating apparatus in accordance with the first aspect of the disclosure;
mounting the powder coating apparatus onto the pipe workpiece in the region of the weld zone;
connecting the one or more powder inlets of the powder chamber of the coating head of the powder coating apparatus to a source of a selected powderized coating material;
connecting the one or more vacuum outlet ports of the vacuum chamber of the coating head to a source of vacuum;
applying heat to the weld zone of the pipe workpiece sufficient for fusion of the coating material to the workpiece;
actuating the source of vacuum;
initiating the flow of coating material into the powder chamber such that the coating material is discharged through the one or more powder discharge outlets of the powder chamber and toward the weld zone of the workpiece; and
selectively adjusting the rate of flow of coating material into the powder chamber and the rate of flow of coating material into the vacuum chamber to achieve a desired thickness of coating over the weld zone.

### BRIEF DESCRIPTION OF THE DRAWINGS

Embodiments in accordance with the present disclosure will now be described with reference to the accompanying figures, in which numerical references denote like parts, and in which:

FIG. 1 is an isometric view of an exemplary embodiment of a carriage-mounted coating head in accordance with the present disclosure, shown mounted on a pipe.

FIG. 2 is an enlarged isometric view of the coating head in FIG. 1.

FIG. 3 is a further enlarged isometric view of the coating head in FIG. 1, illustrating the powder discharge outlet of the powder chamber and the vacuum inlets of the vacuum chambers.

### DETAILED DESCRIPTION

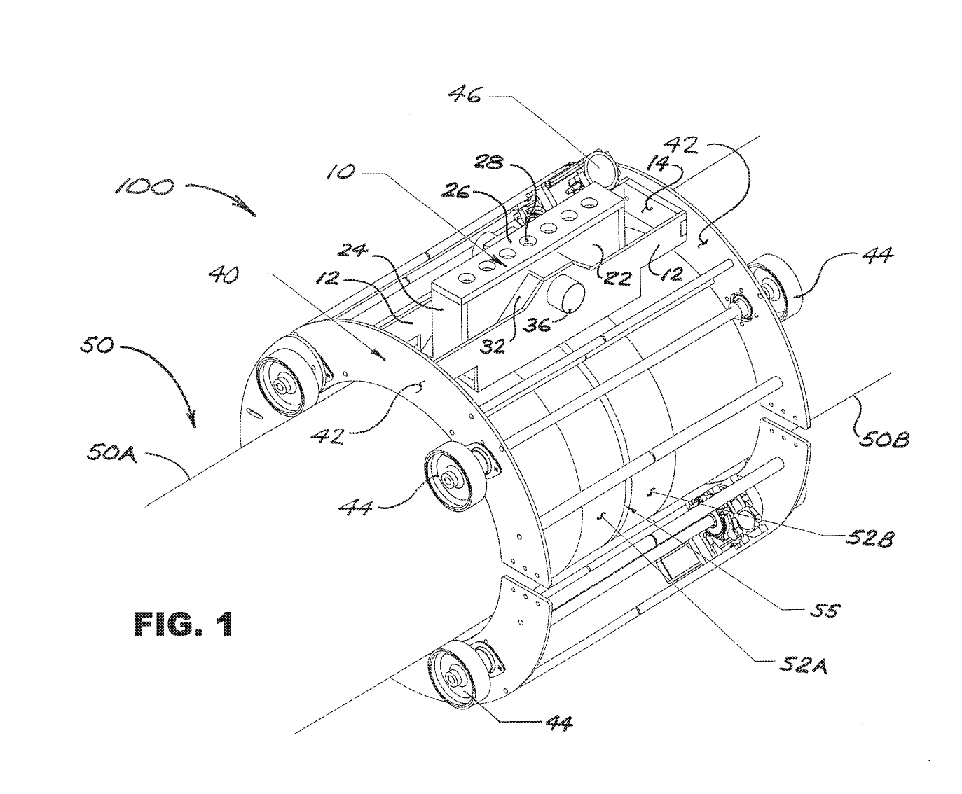

FIG. 1 illustrates one embodiment of a powder coating application apparatus 100 in accordance with the present disclosure, mounted around on a pipe assembly 50 formed by two coaxially-aligned sections 50A and 50B of coated pipe that have been joined end-to-end by a circumferential welded joint 55 subsequent to the removal the coating in cut-back areas 52A and 52B at the ends of pipe sections 50A and 50B, respectively. Apparatus 100 includes a coating head 10 mounted in a coating head carriage 40 adapted for mounting to pipe assembly 50 such that carriage 40 can traverse a weld zone comprising welded joint 55 and cut-back areas 52A and 52B (typically but not necessarily by way of oscillating circular movements), while keeping coating head 10 at a set radial distance from the pipe surface. Various types of carriages suitable for this purpose are known in the art, and apparatus in accordance with the present disclosure are not restricted or limited to the use of any particular type of carriage or carriage structure to provide the required functionality.

In the illustrated embodiment, and by way of example only, carriage 40 has curved side rails 42 which carry pipe-engaging wheels 44 driven by a carriage drive motor 46 (which may be of any suitable type, such as but not limited to electric or hydraulic). Although not illustrated in detail in FIG. 1, carriage side rails 42 may be hinged to facilitate mounting on pipe assembly 50, with suitable latch means for retaining carriage 40 in position on pipe assembly 50 while in operation. Coating head 10 is shown as being mounted between carriage side rails 42. Coating head 10 could be rigidly mounted to carriage 40, so as to permanently position coating head 10 at a fixed radial distance from the centerline of pipe assembly 50. In alternative embodiments, coating head 10 could be mounted to carriage 40 so as to facilitate adjustment of its radial position.

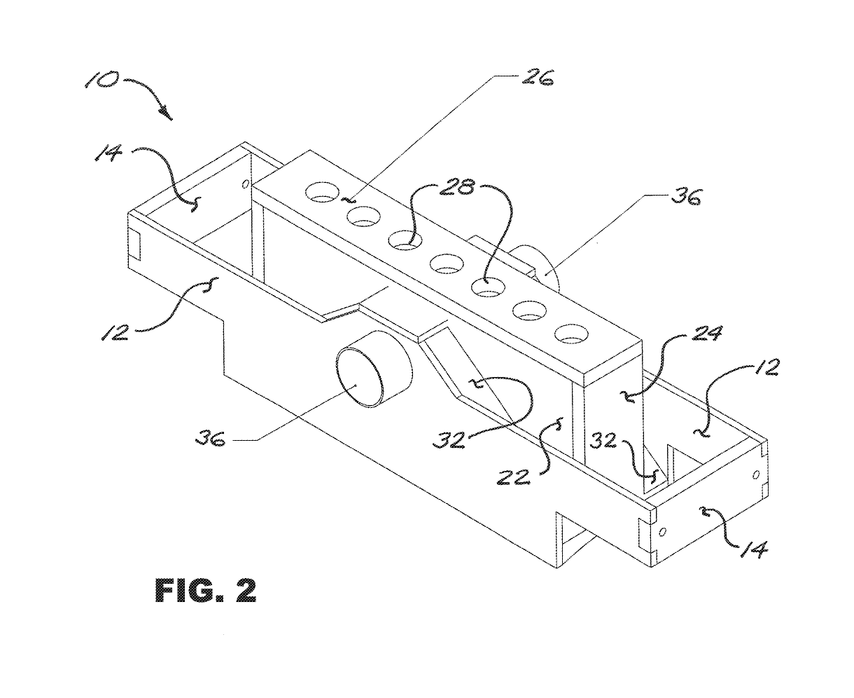

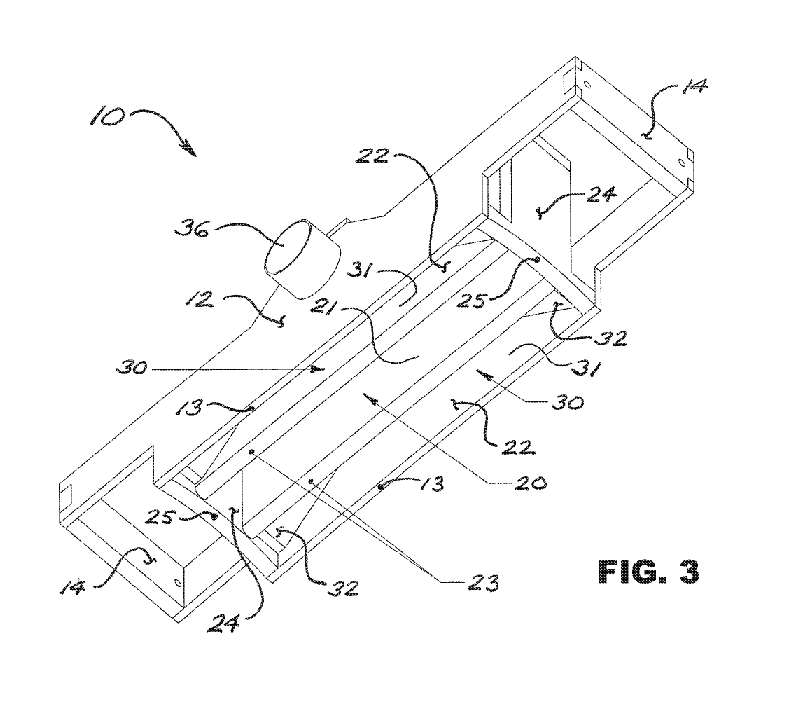

FIGS. 2 and 3 illustrate coating head 10 in greater detail. In the illustrated embodiment, coating head 10 comprises two spaced side beams 12 separated by two end members 14. A powder chamber 20 is defined by a pair of powder chamber sidewalls 22 spanning between a pair of powder chamber endwalls 24, which in turn span between side beams 12. Powder chamber 20 is provided with one or more powder inlets 28 for introducing an air/powder suspension into powder chamber 20. In the illustrated embodiments, powder inlets 28 are provided in the form of nozzle ports through a nozzle plate 26 in the upper (i.e., radially-outward) region of powder chamber 20. However, this is by way of non-limiting example only, and powder inlets could be provided in other forms using different structure without departing from the scope of the present disclosure. For example, in alternative embodiments powder inlets could be provided in powder chamber sidewalls 22 and/or in powder chamber endwalls 24, with the upper region of powder chamber 20 being capped off with a solid plate.

Powder chamber 20 also has at least one powder discharge outlet 21 suitably positioned to deliver the air/powder suspension to the weld zone of a pipe workpiece. In the illustrated embodiment (and as best seen in FIG. 3), a powder discharge outlet 21 is provided in the form of an opening extending across the lower (i.e., radially-inward) side of powder chamber 20. However, this is by way of non-limiting example only, and embodiments in accordance with the present disclosure are not limited to this particular form or configuration of powder discharge outlets. For example, in unillustrated alternative embodiments, the lower side of powder chamber 20 could have a cover plate with perforations that serve as powder discharge outlets.

As best seen in FIG. 3, the lower (i.e., radially-inward) edges 25 of powder chamber endwalls 24 optionally may be contoured to conform with the curvature of pipe assembly 50. Although not illustrated as such in FIG. 3, the lower edges 23 of powder chamber sidewalls 22 optionally may be similarly contoured.

The illustrated embodiment of coating head 10 also includes a pair of vacuum chambers 30, one on either side of powder chamber 20. Each vacuum chamber 30 is defined by a portion of one of the side beams 12, the adjacent powder chamber sidewall 22, and one or more vacuum chamber roof members 32 extending between the respective side beams 12 and powder chamber sidewalls 22.

Each vacuum chamber 30 has at least one vacuum inlet 31 suitably positioned to receive excess air/powder suspension from the weld zone. In the illustrated embodiment (and as best seen in FIG. 3), each vacuum chamber 30 has a vacuum inlet 31 in the form of an opening across its lower (i.e., radially-inward) side. However, this is by way of non-limiting example only, and embodiments in accordance with the present disclosure are not limited to this or any other particular form or configuration of vacuum inlets. For example, in unillustrated alternative embodiments, the radially-inward side of vacuum chamber 30 could have a cover plate with one or more openings or perforations that serve as vacuum inlets.

One or more vacuum outlet ports 36 are provided for each vacuum chamber 30, connectable to a source of vacuum to facilitate exhausting of excess air/powder suspension entering vacuum chamber 30 from the weld zone via vacuum inlet 31.

It is to be noted that the radial positions of lower edges 13 of side beams 12 in the vicinity of vacuum chambers 30 could match the radial positions of lower edges 23 of powder chamber sidewalls 22, but this is not essential. In alternative embodiments, lower edges 13 could be positioned either radially inward or radially outward of lower edges 23.

The illustrated structural configuration of vacuum chambers 30 is by way of non-limiting example only, and alternative embodiments of coating head 10 could have functionally suitable vacuum chambers of other structural configurations without departing from the scope of the present disclosure. As well, although the illustrated embodiment incorporates two vacuum chambers, alternative embodiments could have only a single vacuum chamber.

The “Brief Summary” section of this disclosure provides a general description of the operation of powder coating application apparatus 100.

It is to be understood that the scope of the present disclosure should not be limited by the any particular embodiment or embodiments described and illustrated herein, but should be given the broadest interpretation consistent with the disclosure as a whole. It is also to be understood that the substitution of a variant of a claimed element or feature, without any substantial resultant change in functionality, will not constitute a departure from the scope of the disclosure.

In this patent document, any form of the word “comprise” is to be understood in its non-limiting sense to mean that any element following such word is included, but elements not specifically mentioned are not excluded. A reference to an element by the indefinite article “a” does not exclude the possibility that more than one such element is present, unless the context clearly requires that there be one and only one such element.

The use of any form of any term describing an interaction between elements (such as but not limited to “connect”, “engage”, “mount”, or “attach”) is not intended to limit the interaction to direct interaction between the subject elements, and may also include indirect interaction between the elements such as through secondary or intermediary structure. Relational or relative terms (such as, but not limited to, “horizontal”, “vertical”, “parallel”, “perpendicular”, “coaxial”) are not intended to denote or require absolute mathematical or geometrical precision. Accordingly, such terms are to be understood as denoting or requiring substantial precision only (e.g., “substantially horizontal”) unless the context clearly requires otherwise.

Wherever used in this document, the terms “typical” and “typically” are to be interpreted in the sense of being representative of common usage or practice, and are not to be understood as implying invariability or essentiality.

What is claimed is:

1. A coating head comprising:
(a) a powder chamber having one or more powder inlets and one or more powder discharge outlets, said one or more powder inlets being connectable to a source of a powderized coating material; and
(b) a vacuum chamber having one or more vacuum inlets and one or more vacuum outlet ports, said one or more vacuum outlet ports being connectable to a source of vacuum;
wherein:
(c) the coating head is mountable on a coating head carriage adapted for mounting to a pipe so as to be circumferentially traversable around the pipe while maintaining the coating head a desired radial distance from the pipe surface, with the one or more powder discharge outlets being directed radially inward toward the surface of the pipe to enable the flow of coating material to a selected pipe surface region, and with the one or more vacuum inlets being positioned to enable the flow of coating material from the selected pipe surface region into the vacuum chamber;
(d) the rate of flow of powderized coating material into the powder chamber is selectively variable; and
(e) the rate of flow of powderized coating material into the vacuum chamber is selectively variable.

2. A coating head as in claim 1 wherein the coating material is in the form of an air/powder suspension.

3. A coating head as in claim 1 wherein the powder chamber shares a common wall with at least one of the at least one vacuum chambers.

4. A coating head as in claim 1 wherein the one or more powder inlets comprise one or more nozzle ports formed in a nozzle plate in an upper region of the powder chamber.

5. A coating head as in claim 1 wherein the powder chamber is defined by a pair of spaced sidewalls extending between a pair of endwalls, and wherein the one or more powder inlets are provided in said sidewalls or in said endwalls.

6. A coating head as in claim 1 wherein the powder discharge outlet is an opening extending across a lower region of the powder chamber.

7. A coating head as in claim 1 wherein at least one of the one or more vacuum inlets is an opening extending across a lower region of the corresponding vacuum chamber.

8. A powder coating apparatus comprising a coating head as in claim 1, and including the coating head carriage.

9. A powder coating apparatus as in claim 8 wherein the coating head carriage has curved side rails which carry pipe-engaging wheels driven by a carriage drive motor.

10. A powder coating apparatus as in claim 9 wherein the side rails of the coating head carriage are hinged to facilitate mounting on a pipe.

11. A powder coating apparatus as in claim 8 wherein the radial position of the coating head is adjustable.

12. A method for applying a powder coating to a weld zone associated with a circumferential welded joint on a pipe workpiece, said method comprising the steps of:
(a) providing a powder coating apparatus as in claim 8;
(b) mounting the powder coating apparatus onto the pipe workpiece in the region of the weld zone;
(c) connecting the one or more powder inlets of the powder chamber of the coating head of the powder coating apparatus to a source of a selected powderized coating material;
(d) connecting the one or more vacuum outlet ports of the vacuum chamber of the coating head to a source of vacuum;
(e) applying heat to the weld zone of the pipe workpiece sufficient for fusion of the coating material to the workpiece;
(f) actuating the source of vacuum;
(g) initiating the flow of coating material into the powder chamber such that the coating material is discharged through the one or more powder discharge outlets of the powder chamber and toward the weld zone of the workpiece; and
(h) selectively adjusting the rate of flow of coating material into the powder chamber and the rate of flow of coating material into the vacuum chamber to achieve a desired thickness of coating over the weld zone.
